(19) United States
(12) Patent Application Publication
(10) Pub. No.: US 2026/0029791 A1
(43) Pub. Date: Jan. 29, 2026

(54) RIDE VEHICLE POSITIONING SYSTEM

(71) Applicant: Universal City Studios LLC, Universal City, CA (US)

(72) Inventors: Eric To Chan, Lakeland, FL (US); Cole Hirapara, Orlando, FL (US)

(21) Appl. No.: 19/275,675

(22) Filed: Jul. 21, 2025

Related U.S. Application Data
(60) Provisional application No. 63/676,729, filed on Jul. 29, 2024.

(51) Int. Cl. G05D 1/242; A63G 31/02; G01S 13/88; G05D 107/00

(52) U.S. Cl. CPC G05D 1/242; A63G 31/02; G01S 13/885; G05D 2107/87

(57) ABSTRACT

Present embodiments are directed to novel vehicle positioning techniques for determining a position of a vehicle in an amusement park. Provided herein is a vehicle positioning system, which includes a ride vehicle configured to travel along a ride path of a ride attraction. The ride vehicle may include a ground-penetrating radar to emit electromagnetic radiation into the ride path to detect underground structures embedded therein, which may cause a receiver of the ride vehicle to receive variations in returned electromagnetic radiation signals. Based on the returned electromagnetic radiation signals, the vehicle positioning system may determine vehicle position based on signals characteristic of particular path features.

### CROSS-REFERENCE TO RELATED APPLICATION

This application claims priority from and the benefit of U.S. Provisional Application Ser. No. 63/676,729, entitled “RIDE VEHICLE POSITIONING SYSTEM,” filed Jul. 29, 2024, which is hereby incorporated by reference in its entirety.

### BACKGROUND

The present disclosure relates generally to vehicle positioning techniques. More specifically, embodiments of the present disclosure relate to systems and methods for positioning vehicles within an amusement park.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Amusement parks or similar entertainment facilities may include various attractions and destinations, such as ride attractions, theaters, arcades, restaurants, rest areas, information centers, gift shops, and other park facilities, to provide enjoyment to their guests. To increase park attendance, an amusement park may include a range of different ride attractions (e.g., thrill rides, dark rides, water rides, family rides) to cater to various types of guests. In addition, the amusement park may desire to improve guest experiences at the ride attractions and/or in the park, as doing so may create additional incentives for potential guests to visit the amusement park. For example, the amusement park may desire to create newer and grander ride attractions and/or improved facilities may be built. As such, advancement in ride/park operations to is generally perceived as desirable.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In accordance with an embodiment of the present disclosure, an amusement park attraction system includes a ride vehicle configured to travel within an attraction and an attraction controller. The ride vehicle includes at least one ground-penetrating electromagnetic emitter configured to emit electromagnetic radiation towards one or more path features of the attraction, at least one receiver configured to receive reflected electromagnetic radiation returned from the one or more path features, and a vehicle controller configured to drive the ride vehicle within the attraction based on a control signal. The attraction controller is configured to receive data from the at least one receiver and determine a location of the ride vehicle within the attraction, generate the control signal for the ride vehicle based on the location, and transmit the control signal to the vehicle controller of the ride vehicle.

In accordance with another embodiment of the present disclosure, a ride vehicle includes at least one ground-penetrating electromagnetic emitter configured to emit electromagnetic radiation towards one or more path features of an attraction, at least one receiver configured to receive reflected electromagnetic radiation returned from the one or more path features of the attraction, a vehicle controller configured to drive the ride vehicle within the attraction based on a control signal, and communication circuitry. The at least one electromagnetic emitter and the at least one receiver are positioned on an exterior surface of the ride vehicle. The communication circuitry is configured to communicate with an attraction controller to transmit data from the at least one receiver and receive the control signal from the attraction controller, where the control signal is based on the data.

In accordance with a further embodiment of the present disclosure, an amusement park attraction method includes receiving ground-penetrating radar data from a ride vehicle. The method also includes determining that the ground-penetrating radar data is indicative of a detected individual path feature of path features of an attraction, and determining a location of the ride vehicle within the attraction based on the detected individual path feature. The method further includes generating a control signal for the ride vehicle based on the location and transmitting the control signal to a vehicle controller of the ride vehicle.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic illustration of an amusement park attraction including a vehicle positioning system, in accordance with embodiments described herein;

FIG. 2 is a block diagram of components of the vehicle positioning system, in accordance with embodiments described herein;

FIG. 3 is a schematic illustration of a vehicle of the vehicle positioning system operating on a road path, in accordance with embodiments described herein; and

FIG. 4 is a schematic illustration of an embodiment of the road path of the vehicle positioning system, in accordance with embodiments described herein.

### DETAILED DESCRIPTION

One or more specific embodiments will be described below. In an effort to provide a concise description of these embodiments, not all features of an actual implementation are described in the specification. It should be appreciated that, in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As noted above, an amusement park may desire to improve a guest experience by making advancements in operations of ride attractions and/or the park in general. For example, guest throughput in attractions may be improved by more accurate monitoring of ride vehicle positions within a ride. In some cases, a guest experience may be improved by providing a robust transit system within or between various attractions. Monitoring of ride vehicle motion along a path, such as a railway or a track, during a ride cycle to monitor each vehicle's position on the track may be conducted using sensors mounted at various locations along the track and complex wiring for connecting each sensor and the computer. However, the ride vehicles in such a system follow a fixed ride track, which reduces the potential for adjustments to the ride without reconstructing the track. In contrast, trackless ride vehicles may enable more flexible ride designs and provide a better guest experience. For example, the trackless ride vehicles may take the guests on different ride paths and/or make unexpected motions. The lack of the ride track of the trackless ride vehicles may provide a smoother ride experience and remove the possibility of spoiling the ride path to the guests, thus creating a much more immersive guest experience.

It should be noted that, without a ride track, the ride vehicles are monitored to ensure accurate positioning and to provide a seamless ride experience. However, monitoring of trackless ride vehicle motion is more complex than that of their tracked counterpart. Without a ride track, sensors that may be associated with the ride track must be repositioned and/or redesigned, making accurate positioning of the ride vehicles difficult. Therefore, it is recognized that there presents a need for novel vehicle positioning techniques that may be implemented in a trackless environment. While location may be estimated from technologies such as global positioning systems, these systems may not provide the desired accuracy (e.g., within a meter).

With this in mind, present embodiments are directed to novel vehicle positioning techniques for determining a position (e.g., location, roll angle, pitch angle, yaw angle, velocity, angular velocity, acceleration, angular acceleration) of a vehicle in an amusement park. Provided herein is a vehicle positioning system, which includes a vehicle (e.g., a ride vehicle) configured to travel along a path, such as a ride path of a ride attraction. The ride vehicle may include a ground-penetrating radar to emit electromagnetic radiation into the ride path to detect underground structures embedded therein, which may cause a receiver of the ride vehicle to receive variations in returned electromagnetic radiation signals. Based on the returned electromagnetic radiation signals, the vehicle positioning system may determine underground features of the segment of ride path underneath the ride vehicles. As such, the vehicle positioning system may accordingly determine a position (e.g., location, roll angle, pitch angle, yaw angle, velocity, angular velocity, acceleration, angular acceleration) of the ride vehicle. Further, the vehicle positioning system may drive the ride vehicle along the ride path based on the determined position of the ride vehicle. As such, the vehicle positioning system may position the location of the ride vehicle and/or guide the ride vehicle accordingly even without a ride track.

However, it should be appreciated that the vehicle positioning system described herein may also be implemented in may be implemented in a ride attraction with a ride track to provide additional positioning of the ride vehicles. Further, it should be appreciated that the vehicle positioning system described herein may be implemented in an autonomous driving system or an assistive driving system. For example, the autonomous driving system or the assistive driving system may position a vehicle and drive the autonomous vehicle accordingly via the vehicle positioning system. Additionally or alternatively, the amusement park may position one or more transportation vehicles in the park via the vehicle positioning system and cause a specific transportation vehicle (e.g., nearest autonomous vehicle) to pick up and transport a guest to a park destination. It should also be appreciated that the vehicle positioning system described herein may be implemented in other locations other than an amusement park. For example, the vehicle positioning system may be implemented in other environments such as a resort, a restaurant, a warehouse, a manufacturing facility, etc. to position and/or control the vehicles therein. Indeed, the vehicle positioning system described herein may be implemented in any suitable environment to position and/or control a vehicle based on the electromagnetic radiation feedback of the embedded underground structures of the ride path.

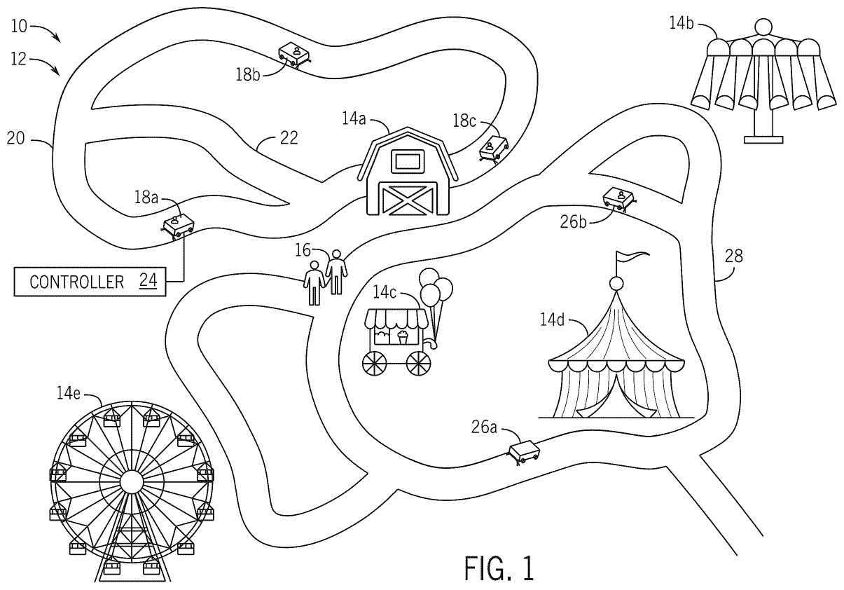

To that end, the features of a vehicle positioning system as provided herein may be used in conjunction with the disclosed embodiments. FIG. 1 is a schematic view of an amusement park 10 including a vehicle positioning system 12. The amusement park 10 may include a number of destinations and attractions 14 (shown as 14a-e) to provide enjoyment to guests 16. The amusement park 10 may implement the vehicle positioning system 12 in various ways to position various types of vehicles within the amusement park 10.

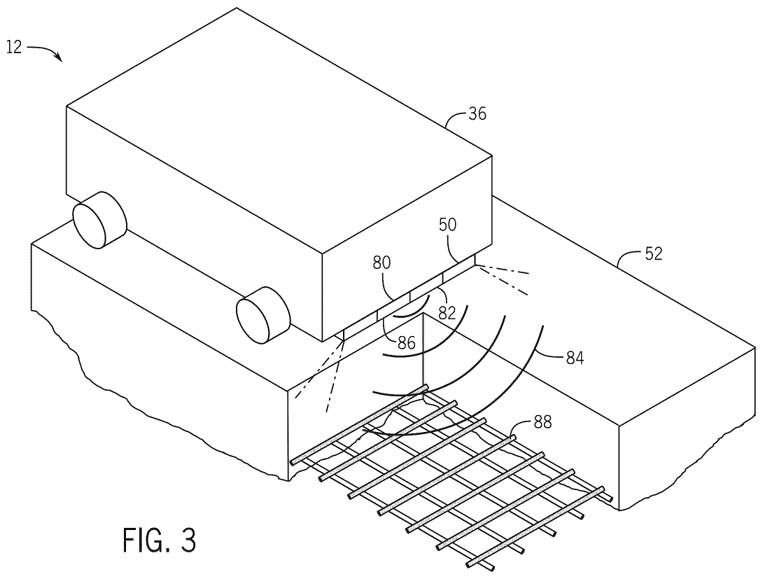

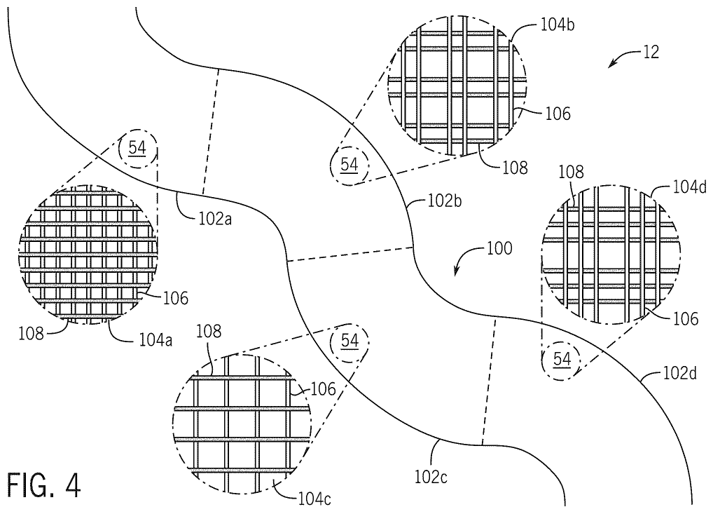

For example, the vehicle positioning system 12 may provide accurate positioning of vehicles within a specific destination or attraction of the destinations and attractions 14. In the illustrated embodiment, the guest 16 may visit the ride attraction 14a, which may include the vehicle positioning system 12 to position one or more ride vehicles 18 (shown as 18a-c) on a ride path 20. As discussed herein, the ride path 20 may be a predetermined path, or a variable or dynamic path that is determined at least in part in real-time. For example, the vehicle positioning system 12 may be configured with path determination logic that uses vehicle position information as an input. Other inputs may include positions of nearby ride vehicles 18 or other obstacles. In certain cases, the inputs may be attraction timing inputs that are used to align vehicle position with effects in an attraction narrative. The ride vehicles 18 may each include a ground-penetrating radar to emit electromagnetic radiation into or through a ground surface, such as the ride path 20, to detect underground structures embedded therein, which may cause a receiver of the ride vehicle 18 to receive variations in returned electromagnetic radiation signals that are reflected from the structures. Based on the returned electromagnetic radiation signals, the vehicle positioning system 12 may determine underground features of the segment of ride path 20 underneath the ride vehicles 18. As such, the vehicle positioning system 12 may accordingly determine a position (e.g., location, roll angle, pitch angle, yaw angle, velocity, angular velocity, acceleration, angular acceleration) of the corresponding ride vehicle of the one or more ride vehicles 18. Various aspects of the ride path 20 and the underground structures embedded therein are discussed in further detail below with respect to FIGS. 3 and 4.

In one embodiment, the vehicle positioning system 12 may control the ride vehicles 18 based on the determined positions of the ride vehicles 18 via an attraction controller 24, which may be wirelessly coupled to the ride vehicles 18. For example, the vehicle positioning system 12 may determine that the ride vehicle 18a is currently at a certain location along the ride path 20, and the vehicle positioning system 12 may accordingly instruct, via the attraction controller 24, the ride vehicle 18a to accelerate, decelerate, steer left, steer right, spin, flip, or perform any other maneuvers. In one embodiment, the vehicle positioning system 12 may determine respective positions for one or more ride vehicles 18 at ride attraction 14a, and, accordingly, control, via the attraction controller 24, a specific ride vehicle 18 of the one or more ride vehicles 18 based on the positions of the other ride vehicles 18 of the one or more ride vehicles 18, in addition to the position of the specific ride vehicle 18. For example, the vehicle positioning system 12 may determine that a certain number of ride vehicles 18 are on the primary ride path 20, the vehicle positioning system 12 may divert, via the attraction controller 24, a specific ride vehicle 18 to an alternative path 22. As another example, the vehicle positioning system 12 may determine that a first ride vehicle 18a of the one or more ride vehicles 18 is within a certain distance ahead of a second ride vehicle 18b along the ride path 20, and, accordingly, instruct, via the attraction controller 24, the first ride vehicle 18a to accelerate, the second ride vehicle 18b to decelerate, or both, to maintain a minimum distance between ride vehicles 18. In an embodiment, the vehicle positioning system 12 may generate a new ride path for one or more ride vehicles 18 based on the ride vehicle positions.

In one embodiment, each of the one or more ride vehicles 18 may be operated by a driver (e.g., the guest 16, designated driver, ride operator). The guest 16 may be dispatched to operate one of the ride vehicles 18 and provide control inputs to the ride vehicle 18. For example, the guest 16 may drive the ride vehicle 18 by pressing a pedal and turning a steering wheel during a ride, where the ride vehicle 18 is configured to provide real-life driving experience. In one embodiment, the vehicle positioning system 12 may continuously position the ride vehicle 18 to monitor its movement. Additionally, the vehicle positioning system 12 may be configured to output certain signals/instructions via the attraction controller 24. For example, the vehicle positioning system 12 may determine that a ride vehicle 18 is within a certain distance from an edge of the ride path 20 and provide an indication to the guest 16 accordingly to prompt the guest 16 to reposition the ride vehicle 18. In one embodiment, the vehicle positioning system 12 may implement a smart steering option for each ride vehicle 18. For example, if the vehicle positioning system 12 determines that the ride vehicle 18 is off the course of the ride path 20 or performing restricted maneuvers, the vehicle positioning system 12 may overwrite the control inputs provided by the guest 16 and control the ride vehicle 18 until the ride vehicle 18 is back on the ride path 20.

In one embodiment, the ride attraction 14a may be a racing attraction, where a plurality of ride vehicles 18 may be dispatched at a same time to provide racing experience in a themed environment. In one embodiment, the vehicle positioning system 12 may position the plurality of dispatched ride vehicles 18 and implement smart steering options to assist the drivers (e.g., guests 16) with operations of the ride vehicles 18. In one embodiment, the vehicle positioning system 12 may implement dynamic balancing adjustment to the ride vehicles 18 to ensure guests 16 having various driving/racing experience have a fair chance and an enjoyable experience. For example, the vehicle positioning system 12 may determine that a first ride vehicle 18a of the one or more ride vehicles 18 is leading the other vehicles on the ride path 20 and a second ride vehicle 18b of the one or more ride vehicles 18 is behind the other vehicles; accordingly, the vehicle positioning system 12 may dynamically adjust the difficulty to run the race for the ride vehicles 18 by means such as guiding a first vehicle 18a to a more difficult ride path and guiding a second vehicle 18b to a simpler ride path or adjusting the resistance to the operations of ride vehicles 18.

In one embodiment, the ride vehicles 18 may be operated entirely by the attraction controller 24. The guests of the ride attractions 14a, such as the guest 16, may board the ride vehicles 18 as passengers. The attraction controller 24 may position and drive the ride vehicles 18 such that the ride vehicles 18 may appear to race each other. Without the necessity of ride tracks, the ride vehicles 18 may be instructed by the attraction controller 24 to travel on more complex ride paths and create more realistic racing environment. In one embodiment, the attraction controller 24 may instruct the ride vehicles 18 to perform controlled maneuvers. For example, the attraction controller 24 may position the ride vehicles 18 and instruct the ride vehicles 18 to perform a series of turns when the ride vehicles 18 are determined to have entered a S-shaped section of the ride path 20. As another example, the attraction controller 24 may instruct the ride vehicles 18 to perform a controlled crash into an object, such as a wall, of the ride attraction 14a and/or a controlled spin to simulate a race crash. In one embodiment, the vehicle positioning system 12 may position a plurality of ride vehicles 18 that are in close proximity to each other and instruct the plurality of ride vehicles 18 to collaborate and simulate complex racing techniques. For example, the vehicle positioning system 12 may identify two ride vehicles that are in close proximity to each other on the ride path 20 and may instruct the two ride vehicles to perform slipstreaming/drafting maneuvers (e.g., where a first ride vehicle 18a follows closely behind a second ride vehicle 18b and eventually gains a speed advantage over the second ride vehicle 18b).

The vehicle positioning system 12 may also be implemented to improve the general transportation within the amusement park 10, such as among destinations and attractions 14. In the illustrated embodiment, the guest 16 may wish to transport from a location (e.g., near the attraction 14c) to a particular destination within the amusement park 10 on one of transportation vehicles 26 (shown as 26a and 26b), which may be positioned and controlled by the vehicle positioning system 12. The transportation vehicles 26 may travel along park paths 28, which connect the various destinations and attractions 14, to provide fast and convenient transportation within the amusement park 10.

In one embodiment, the vehicle positioning system 12 may position the transportation vehicles 26 in response to a transportation request to pick up the guest 16 at the guest location. In an embodiment, the guest 16 may initiate the transportation request via a guest device, a vehicle call station, or any other guest input device, which may include application or specialty software package for generating the transportation request. In one embodiment, the vehicle positioning system 12 may receive information associated with the transportation request, such as the guest location, number of guests, guest information, and other information, to enable vehicle control for autonomous driving to the guest location. In one embodiment, communication between the attraction controller 24 and the guest input device (e.g., guest device, or the vehicle call station) may occur at least in part via a wireless network.

In one embodiment, the transportation vehicles 26 may be operated autonomously without a driver. For example, the vehicle positioning system 12 may identify an unoccupied transportation vehicle 26a close to a certain destination (e.g., the location of the guest 16), generate a travel plan for traveling to the destination (e.g., the location of the guest 16), and control the transportation vehicle 26a based on the generated travel plan. In such embodiment, the vehicle positioning system 12 may continuously monitor the position of the transportation vehicles 26 and output instructions to drive the transportation vehicles 26 according to the travel plan. In another embodiment, the transportation vehicles 26 may only be operated manually by certified drivers, such as park employees. The vehicle positioning system 12 may identify an unoccupied transportation vehicle 26a close to the location of the guest 16 and output a signal to notify a driver of the transportation vehicle 26a to pick up the guest 16. Alternatively, the transportation vehicles 26 may be available for the guests, such as guest 16, to utilize. The vehicle positioning system 12 may position the transportation vehicles 26 and output a signal to notify the guest 16 of the unoccupied transportation vehicles available near the location of the guest 16, such that the guest 16 may locate an unoccupied transportation vehicle based on the signal. The vehicle positioning system 12 may visualize the positions of the transportation vehicles 26 on display devices of the transportation vehicles 26, the guest devices (e.g., the guest device), the vehicle call stations, or any other output devices.

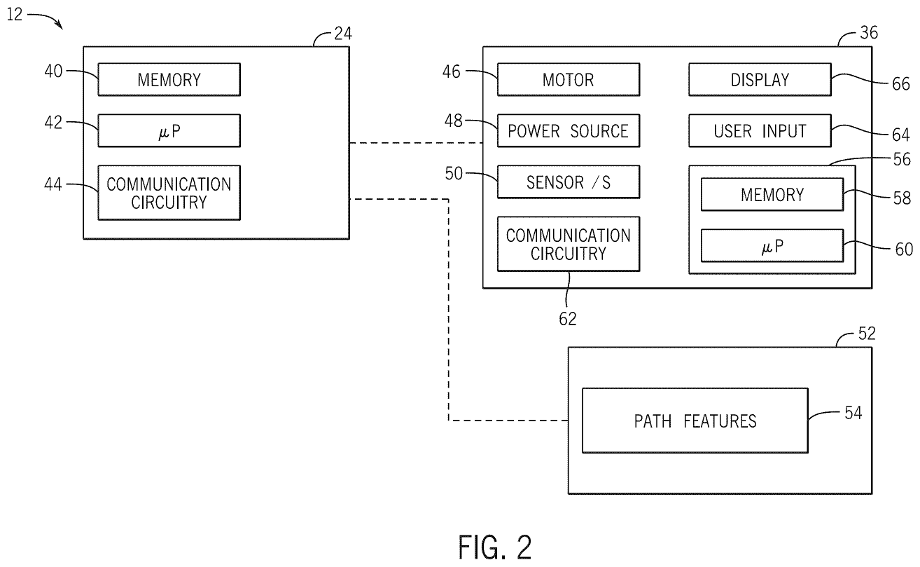

FIG. 2 is a block diagram of certain components of the vehicle positioning system 12 discussed in FIG. 1. It should be understood that the illustrated components may have additional software or hardware elements. Further, the functionality of various disclosed hardware or software elements may be duplicated and/or exchanged in the illustrated components.

The vehicle positioning system 12 may be configured to operate at least in part via instructions from the attraction controller 24, e.g., a system controller, which may include memory 40 for storing instructions executable by a processor 42 to perform the methods and control actions described herein. The processor 42 may include one or more processing devices, and the memory 40 may include one or more tangible, non-transitory, machine-readable media. By way of example, such machine-readable media can include RAM, ROM, EPROM, EEPROM, CD-ROM, or other optical disk storage, magnetic disk storage or other magnetic storage devices, or any other medium which can be used to carry or store desired program code in the form of machine-executable instructions or data structures and which can be accessed by the processor 42 or by a special purpose or programmed computer or other machine with a processor. In addition, the attraction controller 24 may be configured to include communication circuitry 44, e.g., a transceiver or other communication devices to communicate over wired and wireless communication paths with one or more other components of the vehicle positioning system 12.

As discussed, the vehicle positioning system 12 may include a vehicle 36 (e.g., ride vehicles 18a, 18b, and/or 18c, transportation vehicles 26a and/or 26b), each including a motor 46, a power source 48 (e.g., a battery, a solar panel, an electrical generator, a gas engine, or any combination thereof), and one or more sensors 50.

The one or more sensors 50 may be configured to acquire sensor data related to determining a position (e.g., location, roll angle, pitch angle, yaw angle, velocity, angular velocity, acceleration, angular acceleration) of the vehicle 36. For example, the one or more sensors 50 may include ground-penetrating radar configured to survey the underground environment underneath a road path 52 (e.g., ride path 20, alternative path 22, park path 28) using radio wave pulses, such as high-frequency pulsed radio waves. For example, the ground-penetrating radar may be configured to emit microwave radiation, including polarized radio waves in a range of 10 MHz to 2.6 GHz. The emitted radio wave pulses may propagate through the underground environment and backscatters when the pulses encounter a material interface of sufficiently different electromagnetic properties. As such, variations of returned pulses may indicate the presence of objects of various electromagnetic properties. In one embodiment, the ground-penetrating radar may be configured to detect radar-reflecting underground structures, such as support structures embedded in the road path 52, the presence of which may be utilized later to determine the position of the vehicle 36. Further, the properties of the returned pulses, such as amplitude variations and travel time, may be further analyzed to determine the features, such as depth, geometry, and other characteristics, of the detected structures. For example, the vehicle positioning system 12 may be configured to determine the position and/or orientation of the detected underground structures. In one embodiment, the ground-penetrating radar may be configured to emit a series of radio wave pulses at a certain frequency to produce two-dimensional radargram based on a series of returned pulses for mapping and/or imaging the underground structures of the road path 52.

In one embodiment, the one or more ground-penetrating radar may include one or more ground-penetrating electromagnetic emitters configured to emit electromagnetic radiation into the road path 52 and one or more receivers configured to receive returned electromagnetic radiation returned from underground structures of the road path 52. Based on the returned electromagnetic radiation, the vehicle positioning system 12 may determine features of the underground features underneath the vehicle 36. The features of the underground structures may include unique path features 54 that differentiate a specific location from the other locations on the road path 52. For example, the returned electromagnetic radiation may indicate that the support structures underneath the vehicle 36 are spaced at a first distance apart and laid at a second distance below the exterior surface of the road path 52. Such path features may be unique to the road path 52; accordingly, the vehicle positioning system 12 may determine a location of the vehicle 36 based on the unique detected path features. For example, the vehicle positioning system 12 may compare the returned electromagnetic radiation, which may be indicative of certain underground path features of the road path 52, with a map of underground path features 54 of the road path 52 to identify a portion of the map corresponding to the certain underground path features and determine the position of the vehicle 36. In an embodiment, the map of underground path features 54 may include position and/or orientation data of the support structures embedded in the road path 52. In one embodiment, the map of the underground path features 54 of the road path 52 may be generated directly through blueprints or construction plans of the road path 52. In another embodiment, the map of underground path features 54 of the road path 52 may be generated during an initial survey of the underground environment using the ground penetrating sensors. For example, a survey vehicle may be deployed to scan the road path 52 and determine the underground path features 54 and store the related information in a memory (e.g., memory 40 of the attraction controller 24).

In some embodiments, one or more path features 54 may be unique relative to one another, such that each path feature 54 appears only once within the park. Thus, identification of the characteristic reflected signal from the unique path feature 54 is determinative for a particular unique location int the park. A path feature 54 may be unique based on one or more of a unique pattern, a unique pitch, a unique material, a unique orientation, or any other suitable unique features detectable by the sensors 50. Individual path features 54 may, in some embodiments, be adjacent to one another or spaced apart with intervening featureless or spacer segments of the path.

Accordingly, the attraction controller 24 of the vehicle positioning system 12 may be configured to determine the location of the vehicle 36 on the road path 52 by executing a feature mapping algorithm. The feature mapping algorithm may compare the returned electromagnetic radiation signals, which may be indicative of immediate path features underneath the vehicle 36 at the time of signal collection, to a database (e.g., map) of path features, where the database of path features may include various locations along the road path 52 and the corresponding path features 54 at the respective locations. As such, the feature mapping algorithm may identify certain individual path features of the path features 54 within the database that resemble the immediate path features 54 the most, and thereby determine a location based on the identified individual path features 54.

In one embodiment, the attraction controller 24 may be configured to preprocess the returned electromagnetic radiation signals in a certain manner to increase accuracy and/or efficiency of the feature mapping algorithm. For example, the attraction controller 24 may create continuous radargram of the immediate underground environment and identify certain underground structures and/or the characteristics of the underground structures. In one embodiment, the attraction controller 24 may be configured to operate certain logic to identify certain characteristics of the underground structures. For example, the attraction controller 24 may be configured to identify a depth, an orientation, a size (e.g., length, width, thickness, radius), a shape, a surface pattern, a layout (e.g., a spacing, a relative orientation), or a combination thereof with respect to an individual underground structure and/or a group of underground structures.

In a certain embodiment, the attraction controller 24 may determine the location of the vehicle 36 on the road path 52 by converting the returned electromagnetic radiation signals to coordinates or other location identifiers through a machine learning model. As used herein, machine learning models refer to algorithms and statistical models that may be used to perform a specific task without using explicit instructions, relying instead on patterns and inference. In particular, a machine learning model generates a mathematical model based on data (e.g., sample or training data) in order to make predictions or decisions without being explicitly programmed to perform the task. For example, the machine learning model is trained on the database of path features to identify patterns and/or relationships between the specific returned electromagnetic radiation signals and its corresponding location. These patterns and/or relationships may be delineated by a process such that returned electromagnetic radiation signals may be converted through certain mathematical and/or statistical operations to a certain classification of various classifications of the machine learning model (e.g., locations on road path 52). As such, the returned electromagnetic radiation signals may be directly converted to the corresponding coordinates and/or other location identifiers.

In a certain embodiment, the attraction controller 24 may store and/or postprocess each of the determined locations to track the movement of the vehicle 36, provide additional positioning information of the vehicle 36, and/or to generate instructions to control the vehicle 36. For example, the controller may determine a driving angle (e.g., roll angle, pitch angle, yaw angle) of the vehicle 36 by determining a travel direction of the radiation signals. As another example, the controller may determine a velocity and/or an acceleration of the vehicle 36 by tracking the changes in locations of the vehicle 36.

In a certain embodiment, the attraction controller 24 may activate and/or deactivate the one or more sensors 50. Specifically, the attraction controller 24 may activate and/or deactivate the one or more sensors 50 based on the determined location of the vehicle 36. As a specific example, the attraction controller 24 may generate instructions to cause the vehicle 36 to perform a controlled backward rolling maneuver in response to determining that the vehicle 36 is positioned at a first location. In the meantime, the attraction controller 24 may deactivate the ground-penetrating radar during the maneuver to block the electromagnetic radiation from emitting into the air.

In a certain embodiment, the one or more sensors 50 may include other types of sensors to provide alternative/additional positioning of the vehicle 36. For example, the one or more sensors may include a global positioning system, an inertial navigation system, vehicle motion sensors, digital road maps, cameras, lidar, laser scanners, or a combination thereof.

A vehicle controller 56 including a memory 58 and a processor 60 may be configured to operate any on-board logic to transmit data associated with the returned electromagnetic radiation and/or other data from the one or more sensors 50 to the attraction controller 24, via communication circuitry 62. Similar to the communication circuitry 44, the communication circuitry 62 may include a transceiver or other communications devices to communicate over wired and/or wireless communication paths with one or more other components of the vehicle positioning system 12. As such, the attraction controller 24 may receive the data and position of the vehicle 36 (e.g., to determine a location, roll angle, pitch angle, yaw angle, velocity, angular velocity, acceleration, angular acceleration of the vehicle 36). For example, the attraction controller 24 may continuously (e.g. at a high frequency) receive data from the receiver of the vehicle 36, determine the location of the vehicle 36 as the vehicle 36 travels on the road path 52, and determine instantaneous velocity and/or acceleration of the vehicle 36 by tracking a change of the location of the vehicle 36. The attraction controller 24 may in return transmit data associated with the determined position of the vehicle 36 back to the vehicle controller 56, via the communication circuitry 62. In one embodiment, the attraction controller 24 may be configured to position one or more vehicles including the vehicle 36. The attraction controller 24 may transmit data associated with the determined positions of some/all of the one or more vehicles to the vehicle 36. However, in some embodiments, one or more operations of the attraction controller 24 may be performed by the vehicle controller 56.

Further, the operations of the motor 46 may be controlled by the vehicle controller 56, which may be configured to operate any on-board logic to control vehicle paths or progress. For example, the attraction controller 24 may generate a control signal specific for the vehicle 36 based on the determined position of the vehicle 36, and the vehicle controller 56 may accordingly control the motor 46 to adjust its output power to accelerate or decelerate the vehicle 36 based on the control signal. As another example, the attraction controller 24 may generate a control signal specific for the vehicle 36 based on the determined positions of one or more vehicles, and the vehicle controller 56 may accordingly control the motor 46 based on the control signal. The vehicle controller 56 may also control a brake to decelerate or stop the vehicle 36, and/or control a steering mechanism to steer left or right. In a certain embodiment, the vehicle controller 56 may operate in response to sensor data indicative of an obstacle on the road path 52. In a certain embodiment, the attraction controller 24 may poll sensors 50 for sensor data continuously, or on a periodic basis, to survey the conditions of the road path 52 to identify any potential road events that may trigger the attraction controller 24 to generate a new control signal. The new control signal may overwrite a previous control signal to change a current course of the vehicle 36 along which the vehicle 36 is currently traveling. For example, the vehicle controller 56 may detect an obstacle, such as a themed prop or a person that may have been within or in close proximity to the course of the vehicle 36 on the road path 52, based on sensor data collected by sensors 50, and control the vehicle to drive around the obstacle in response to detecting the obstacle. Thus, the vehicle positioning system 12 may block the vehicle 36 from a potential collision with another vehicle and/or an obstacle.

In an embodiment, upon receiving the sensor data indicative of the position of the vehicle 36 and other elements (e.g., other vehicles and/or obstacles) on the road path 52, the attraction controller 24 may dynamically determine a course along which the vehicle 36 may travel within the road path 52. The course may be variable based on information associated with the vehicle 36, the passengers of the vehicle 36, and/or the road path 52. For example, a course including a high level of thrill maneuvers may be determined for passengers indicated to have high preferred thrill levels (e.g., based on user-provided preferences or age information associated with the passengers). As such, the vehicle positioning system 12 may enable more flexible ride designs, allowing the guests 16 to travel along a plurality of distinct courses from ride to ride. Accordingly, the attraction controller 24 may generate control signals indicative of the dynamically determined course to direct the vehicle 36 to travel on the dynamically determined course automatically, removing the possibility of spoiling the ride course and/or the maneuvers the vehicle 36 may take to the guests 16 and thus creating a more immersive guest experience.

Alternatively or additionally, the vehicle controller 56 may operate under instructions from passengers of the vehicle 36 via user input 64, such as steering wheel, brake pedal, gas pedal, or from the attraction controller 24, via the communication circuitry 62. The user input 64 may include other input devices such as a touchscreen, a keyboard, a mouse, and/or other devices to receive other user inputs. For example, the user input 64 may be configured to collect user preferences during a ride on the vehicle 36. As a more specific example, the user input 64 may allow guests to provide a preferred thrill level that the vehicle controller 56 may use to accordingly adjust the maneuvers of the vehicle 36 to be performed on the road path 52 and/or select an alternative ride path, from a plurality of available ride paths within the road path 52, based on the provided preferred thrill level.

In one embodiment, the vehicle 36 may further include a display 66. The display 66 may be configured to visualize the position of the vehicle 36. For example, the display 66 may be configured to display a roadmap of the road path 52 and the location of the vehicle 36 on the roadmap. As another example, the display 66 may be configured to display the locations of a plurality of vehicles. As such, the guests on the vehicle 36 may view and compare the vehicle progress on the road path 52. The display 66 may be configured to display other information associated with the vehicle 36. For example, the display 66 may display a speed, acceleration, time (e.g., a time to finish a lap, an elapsed time), distance (e.g., a distance traveled, a distance left to finish a race), position (e.g., a coordinate, ranking, number of laps), and/or other information.

It should be appreciated that although the attraction controller 24 and the vehicle controller 56 are illustrated as two separate components, the attraction controller 24 and the vehicle controller 56 may be combined to a single controller. For example, in a certain embodiment, the attraction controller 24 may include the vehicle controller 56, or vice versa, and configured to operate any logic to position and control the vehicle 36. The attraction controller 24 may be configured to operate any logic described herein associated with the vehicle controller 56; similarly, the vehicle controller 56 may be configured to operate any logic described herein associated with the attraction controller 24.

In a certain embodiment, the vehicle 36 may be an autonomous mobile robot that is provided as a personal locker or roaming dumb waiter. The autonomous vehicle 36 may store image and/or navigation files of the amusement park 10 in the memory 58 such that navigation may be executed using the processor 60 of the vehicle controller 56 to execute on-board logic. In one embodiment, the navigation files may include stored information about path features 54 acquired from a calibration run, such that the vehicle controller 56 is able to determine a position of the vehicle 36 based on a correlation of real-time acquired sensor data 50 to characteristic sensor data generated from the path features 54. The characteristic sensor data may be mapped to particular locations and may be accessed to perform location determination. In an embodiment, the real-time acquired sensor data 50 may be used to identify a best match relative to individual path features of the characteristic sensor data. The location of the best match may then be used as the determined location.

The one or more sensors 50 may include one or more cameras, laser scanners, and/or ultrasonic scanners that may provide inputs to the vehicle controller 56 to execute turns or navigation instructions to avoid obstacles. Further, the sensors 50 may include one or more readers configured to receive biometric input (e.g., a fingerprint, facial image) or a wireless signal from the guest input device (e.g. the guest device) to confirm the presence of a guest 16 and/or to provide guest verification data. In a certain embodiment, the autonomous vehicle 36 may receive a guest identification code or guest identification information that may in turn be passed to the attraction controller 24 to verify that the guest on-board the vehicle 36 is the correct guest. Upon verification, the attraction controller 24 may send an authorization/verification signal that permits the vehicle 36 to continue on a route.

FIG. 3 is a schematic illustration of the vehicle 36 (e.g., ride vehicles 18a, 18b, and 18c, transportation vehicles 26a and 26b) of an embodiment of the vehicle positioning system 12 operating on a portion of the road path 52 (e.g., ride path 20, alternative path 22, park path 28).

As previously discussed with respect to FIG. 2, the vehicle 36 may include one or more sensors 50 configured to acquire sensor data related to determining a position of the vehicle 36. In the illustrated embodiment, the one or more sensors 50 may include one or more ground-penetrating radar 80, comprising one or more ground-penetrating electromagnetic emitters 82 configured to emit electromagnetic radiation 84 into the road path 52, and one or more receivers 86 configured to receive returned electromagnetic radiation returned from underground structures 88 of the road path 52. The ground-penetrating radar 80 may be placed proximate to or in contact with the exterior surface of the road path 52. In the illustrated embodiment, the ground-penetrating radar 80 are located on an exterior surface of the vehicle 36. More specifically, the ground-penetrating radar 80 are located underneath the vehicle 36 and nominally parallel to the exterior surface of the road path 52. In a certain embodiment, the ground-penetrating radar 80 may be configured to emit the electromagnetic radiation 84 downward from the emitters 82 to the underground environment of the road path 52. As such, the electromagnetic radiation 84 may propagate downward from the one or more emitters 82 through the underground environment of the road path 52 and backscatter in an upward direction when the electromagnetic radiation 84 reaches the underground structures 88. Further, the backscattered electromagnetic radiation may be detected by the one or more receivers 86 and processed to determine a position of the vehicle 36. In one embodiment, the one or more ground-penetrating electromagnetic emitters 82 and one or more receivers 86 may be positioned on the vehicle 36 to avoid any intervening structures between the path 52 and the emitters 82/receivers 86.

In the illustrated embodiment, the ground-penetrating radar 80 are arranged together in a linear configuration; however, it should be appreciated that the ground-penetrating radar 80 may not necessarily be arranged in a linear configuration and may be arranged in any suitable arrangements. The ground-penetrating radar 80 may be affixed to the front, as illustrated, or rear of the vehicle 36. In one embodiment, the one or more ground-penetrating electromagnetic emitters 82 may be affixed to the vehicle 36 in front of the one or more receivers 86 in the direction of travel. In one embodiment, multiple sets of emitters 82 and receivers 86 may be affixed to the vehicle 36 in various configurations to emit and collect electromagnetic radiation 84. For example, a first emitter may be positioned at a first end of the vehicle 36 and a second emitter may be positioned at a second end of the vehicle 36. As such, the vehicle positioning system 12 may determine a position of vehicle 36 based on data collected by the multiple sets of emitters 82 and receivers 86 for higher positioning accuracy. The use of multiple emitters 82 and receivers 86 may permit more accurate vehicle orientation determination. That is, in addition to a location estimation, the sensor data may also be used to identify a rotational orientation of the vehicle relative to an individual path feature 54 based on triangulation between different receiver data sets.

In one embodiment, one or more sensors 50 may include sensors other than the ground-penetrating radar 80, such as a global positioning system, an inertial navigation system, vehicle motion sensors, digital road maps, cameras, lidar, laser scanners, or a combination thereof. These sensors may provide alternative/additional positioning of the vehicle 36. For example, the vehicle 36 may additionally include cameras to capture live images of the road path 52 for identifying any landmarks, milestones, turns, obstacles, etc. around the vehicle 36.

In the illustrated embodiment, the underground structures 88 of road path 52 are support structures embedded therein to provide necessary structural support. In one embodiment, the road path 52 may be concrete roads, which may have low tensile strength, and the support structures 88 may be reinforcing bars, which may be configured to strengthen and aid the concrete under tension. The reinforcing bars may be made of carbon steel, stainless steel, glass fiber, carbon fiber, basalt fiber, or any other suitable materials to provide additional tensile strength of the road path 52. For example, the reinforcing bars may be made of certain materials such that the reinforcing bars may have similar coefficients of thermal expansion as concrete to minimize the differential stress on the reinforced concrete structure due to temperature changes. Additionally or alternatively, the reinforcing bars in such embodiment may be configured to have substantially different electromagnetic properties from concrete to cause variations in the returned electromagnetic radiation signals. For example, the reinforcing bars may be coated with a particular material to strengthen the signal magnitude of the returned electromagnetic radiation signals. Further, the reinforcing bars may be configured to include various surface features to further distinguish among the various types of reinforcing bars. For example, the reinforcing bars may include a continuous series of ribs, lugs, indentations, or a combination thereof to create further variations in the returned signals. As such, the vehicle positioning system 12 may determine a location of the vehicle 36 by deciphering the returned signals, which may be indicative of various combinations of materials, coatings, surface features, and other characteristics of the underground structures 88.

As previously discussed, the returned electromagnetic radiation signal may be further processed to determine certain features of the underground structures 88. For example, the travel time of the electromagnetic radiation signal may indicate a depth of the detected underground structures 88. By emitting a series of electromagnetic radiation, a continuous radargram may be produced to map the underground structures 88 of the road path 52. For example, a spacing between support structures underneath may be determined through analyzing a series of returned electromagnetic radiation signals.

The presence of the underground structures 88 within the road path 52 may enable the ground-penetrating radar 80 to capture underground path features that may be utilized for determining the location of the vehicle 36. For example, the arrangement of the support structures may not be unique. The ground-penetrating radar 80 of the vehicle 36 may collect returned electromagnetic radiation at a location indicating that the underground structures 88, such as the support structures, are spaced at a first distance and are disposed at a second distance below the exterior surface of the road path 52. Based on such information regarding the immediate underground features underneath the vehicle 36, the vehicle positioning system 12 may determine the location of the vehicle 36 by identifying a segment of road path 52 that is known to exhibit similar path features as collected. The identifying may be completed in various methods. In one embodiment, a map of path features may be provided and compared with to locate the vehicle 36.

In one embodiment, the road path 52 may include other underground structures that may cause variations in the returned electromagnetic radiation signal. For example, the underground structures 88 may be any subsurface anomalies, geologic structures, or discrete objects that have sufficiently different electromagnetic properties from the primary materials of the road path 52. Such underground structures may be formed during construction; they may be present randomly within the road path 52 at various locations and at various depth. Further, the primary materials of the road path 52 may not be entirely uniform and may also cause variations in the returned electromagnetic radiation signal. For example, the pouring of concrete during construction may cause the road path 52 to form non-uniform layers and/or unique patterns. As such, the non-uniform layers and/or unique patterns of concrete may cause the electromagnetic radiation 84 to be returned in various strength and patterns and enable the vehicle positioning system 12 to identify a location of the vehicle 36 based on the returned electromagnetic radiation signal. In one embodiment, the road path 52 is thoroughly surveyed to collect returned electromagnetic radiation signals throughout and identify such unique underground structures/features that may differentiate a segment of the road path 52 from others.

It should be noted that the underground structures 88 may be configured to be arranged in certain manners during construction of the road path 52 to enable advanced positioning. In one embodiment, the underground structures 88 may be carefully arranged to create unique underground path features. For example, the reinforcement bars may be arranged in a non-repeating tessellating pattern within the road path 52 to enable fast positioning of the vehicle 36, as the individual path features of the road path 52 would be unique to their respective locations. In one embodiment, the underground structures 88 may be arranged in a certain repeated pattern for a particular portion of the road path 52 such that the vehicle positioning system 12 may consistently receive similar returned electromagnetic radiation signals when the vehicle 36 travels on the particular portion of the road path 52. For example, the underground structures 88 of a straight section of the road path 52 may be arranged in a repeated pattern to signify the vehicle positioning system 12 to continue drive the vehicle 36 in a straight direction. That is, in a certain embodiment, the arrangement of the underground structures 88 may be indicative of certain desired control instructions for the vehicle 36. As such, the vehicle positioning system 12 may determine an arrangement of the underground environment immediately underneath the vehicle 36 and generate instructions corresponding to the detected arrangement of the underground structures 88. For example, the attraction controller 24 may generate instructions to cause the vehicle 36 to perform a first maneuver in response to detecting a first arrangement of the underground structures 88, and generate instructions to cause the vehicle 36 to perform a second maneuver different than the first maneuver in response to detecting a second arrangement of the underground structures 88 different than the first arrangement.

With the foregoing in mind, FIG. 4 is a schematic illustration of an embodiment 100 of the road path 52 of the vehicle positioning system 12. In the illustrated embodiment, the road path 100 includes a plurality of sections, where the plurality of sections includes underground structures, or different path features 54, arranged in respective arrangements. For example, a first section 102a of the road path 100 may include a first group of underground structures arranged in a first arrangement 104a, a second section 102b may include a second group of underground structures arranged in a second arrangement 104b, a third section 102c may include a third group of underground structures arranged in a third arrangement 104c, and a fourth section 102d may include a fourth group of underground structures arranged in a fourth arrangement 104d. The vehicle positioning system 12 may receive a return signal indicative of a certain arrangement through sensors implemented in a vehicle as previously described, and determine that the vehicle is located on a section of the road path 100 corresponding to the detected arrangement. The arrangement of the underground structures may be any combination of features, such as depths, orientations, sizes, shapes, spacings, angles, surface characteristics, material characteristics, layouts, or any other characteristics of the underground structures. For example, the underground structures within the section 102a may be placed at a first depth and have a first cross-sectional profile, and the underground structures within the section 102b may be placed at a second depth different than the first depth and have a second cross-sectional profile different than the first cross-sectional profile. Thus, the road path 100 may be carefully configured to create different arrangements of underground structures within the road path 100.

The spacing of the path features 54 may be selected to provide a desired location determination granularity. For example, the path features 54 may be uniquely identifiable within a meter or less than a meter.

As previously discussed, the vehicle positioning system 12 may accordingly generate an output indicative of the determined location of the vehicle. The vehicle positioning system 12 may determine an arrangement of the underground environment immediately underneath the vehicle and generate instructions corresponding to the detected arrangement of the underground structures. For example, the vehicle positioning system 12 may detect the difference in relative placement between vertical underground structures 106 and horizontal underground structures 108 and generate specific outputs in accordance with the relative placement. In the illustrated embodiment, the first arrangement 104a and the third arrangement 104c arrange the respective underground structures such that the vertical underground structures 106 are placed under the horizontal underground structures 108, where the second arrangement 104b and the fourth arrangement 104d arrange the respective underground structures such that the vertical underground structures 106 are placed above the horizontal underground structures 108. Accordingly, the vehicle positioning system 12 may generate instructions to cause vehicles to steer right in response to determining that the vertical underground structures 106 are placed under the horizontal underground structures 108, and steer left in response to determining that the vertical underground structures 106 are placed above the horizontal underground structures 108. That is, the vehicle positioning system 12 may generate instructions to cause vehicles to perform a certain maneuver based on a certain detected feature of the underground structures. Similarly, in the illustrated embodiment, the sections 102 of the road path 100 may include various spacings of the underground structures. Accordingly, the vehicle positioning system 12 may generate instructions to cause vehicles to perform certain maneuvers corresponding to the detected spacings. For example, the vehicle positioning system 12 may generate instructions to cause vehicles to accelerate or decelerate based on a change in detected spacings. As such, the vehicle positioning system 12 may determine a position and/or generate output indicative of the determined position of the vehicle even when no above-the-ground positioning devices/indications are available, such as in a trackless environment.

While only certain features of the disclosed technology have been illustrated and described herein, many modifications and changes will occur to those skilled in the art. It is, therefore, to be understood that the appended claims are intended to cover all such modifications and changes as fall within the true spirit of the disclosure. Furthermore, although the steps of the disclosed flowchart/s are shown in a given order, in certain embodiments, the depicted steps may be reordered, altered, deleted, and/or occur simultaneously.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1.-20. (canceled)

21. An amusement park attraction system, comprising:
a ride vehicle configured to travel within an attraction, wherein the ride vehicle comprises:
at least one ground-penetrating electromagnetic emitter configured to emit electromagnetic radiation towards one or more path features of the attraction;
at least one receiver configured to receive reflected electromagnetic radiation returned from the one or more path features; and
a vehicle controller configured to drive the ride vehicle within the attraction based on a control signal; and
an attraction controller configured to:
receive data from the at least one receiver and determine a location of the ride vehicle within the attraction;
generate the control signal for the ride vehicle based on the location; and
transmit the control signal to the vehicle controller of the ride vehicle.

22. The system of claim 21, wherein the attraction controller comprises memory storing locations of the one or more path features of the attraction.

23. The system of claim 22, wherein the one or more path features comprise at least position data, or orientation data, for embedded support structures under a ground surface of the attraction.

24. The system of claim 23, wherein:
the one or more path features comprise a first section and a second section;
first embedded support structures in the first section comprise a first spacing; and
second embedded support structures in the second section comprise a second spacing different than the first spacing.

25. The system of claim 24, wherein the first section of the one or more path features is proximate to the second section of the one or more path features within the attraction.

26. The system of claim 23, wherein:
the one or more path features comprise a first section and a second section;
first embedded support structures in the first section have a first depth; and
second embedded support structures in the second section have a second depth different than the first depth.

27. The system of claim 23, wherein:
the one or more path features comprise a first section and a second section;
first embedded support structures in the first section have a first shape or profile; and
second embedded support structures in the second section have a second shape or profile different than the first shape or profile.

28. The system of claim 21, wherein the at least one ground-penetrating electromagnetic emitter emits microwave radiation comprising polarized radio waves in a range of 10 MHz to 2.6 GHz.

29. The system of claim 21, wherein the at least one receiver is configured to be in contact with or proximate to the ground surface to receive the reflected electromagnetic radiation.

30. The system of claim 21, wherein a ground surface of the attraction is trackless.

31. A ride vehicle, comprising:
at least one ground-penetrating electromagnetic emitter configured to emit electromagnetic radiation towards one or more path features of an attraction, wherein the at least one electromagnetic emitter is positioned on an exterior surface of the ride vehicle;
at least one receiver configured to receive reflected electromagnetic radiation returned from the one or more path features of the attraction, wherein the at least one receiver is positioned on the exterior surface of the ride vehicle;
a vehicle controller configured to drive the ride vehicle within the attraction based on a control signal; and
communication circuitry configured to communicate with an attraction controller to:
transmit data from the at least one receiver; and
receive the control signal from the attraction controller, wherein the control signal is based on the data.

32. The ride vehicle of claim 31, wherein the vehicle controller is configured to activate and deactivate the at least one electromagnetic emitter.

33. The ride vehicle of claim 31, wherein the at least one electromagnetic emitter comprises a first emitter positioned at a first end of the ride vehicle and a second emitter positioned at a second end of the ride vehicle.

34. An amusement park attraction method, comprising:
receiving ground-penetrating radar data from a ride vehicle;
determining that the ground-penetrating radar data is indicative of a detected individual path feature of an attraction;
determining a location of the ride vehicle within the attraction based on the detected individual path feature;
generating a control signal for the ride vehicle based on the location; and
transmitting the control signal to a vehicle controller of the ride vehicle.

35. The method of claim 34, comprising:
receiving a signal associated with an obstacle;
generating a new control signal for the ride vehicle based on the signal; and
transmitting the new control signal to the vehicle controller of the ride vehicle.

36. The method of claim 34, wherein detecting the individual path feature comprises accessing stored characteristic ground-penetrating radar data of one or more path features and determining a closest match path feature to the ground-penetrating radar data.

37. The method of claim 36, wherein the stored characteristic ground-penetrating radar data of the one or more path features comprise at least position data, or orientation data, for embedded support structures under a ground surface of the attraction.

38. The method of claim 34, comprising determining an orientation of the ride vehicle based on the ground-penetrating radar data.

39. The method of claim 38, comprising generating the control signal for the ride vehicle based on the orientation.

40. The method of claim 34, comprising driving the ride vehicle based on the control signal.
